(19) United States
(12) Patent Application Publication
(10) Pub. No.: US 2024/0251709 A1
(43) Pub. Date: Aug. 1, 2024

(54) LAWN MOWER

(71) Applicant: HONDA MOTOR CO., LTD., Tokyo (JP)

(72) Inventors: Fumio Minami, Wako-shi (JP); Tatsuya Yamazaki, Wako-shi (JP); Taichi Kubota, Wako-shi (JP); Yuko Nishi, Wako-shi (JP); Shin Murakami, Wako-shi (JP); Kento Kimura, Haga-gun (JP)

(21) Appl. No.: 18/160,611

(22) Filed: Jan. 27, 2023

(51) Int. Cl. A01D 34/81

(52) U.S. Cl. CPC A01D 34/81; A01D 2101/00

(57) ABSTRACT

A lawn mower according to the present invention includes: a drive source provided with a rotation shaft; a cutter blade extending in a direction intersecting the rotation shaft; and a housing provided with a peripheral wall surrounding the cutter blade. The cutter blade is provided with a cutting portion, the cutting portion being provided at least at a portion of the cutter blade that faces the peripheral wall, and the peripheral wall is provided with protrusions protruding toward the rotation shaft from a surface of the peripheral wall that faces the direction of the rotation shaft.

### BACKGROUND OF THE INVENTION

### Field of the Invention

The present invention relates to a lawn mower.

### Description of the Related Art

US 2020/0305345 A1 discloses a lawn mower. The lawn mower includes a cutter blade for cutting lawn grass, and a housing for accommodating the cutter blade.

### SUMMARY OF THE INVENTION

There is a long-awaited need for a lawn mower capable of more suitably mowing lawn grass.

An object of the present invention is to solve the above-mentioned problem.

According to an aspect of the present invention, there is provided a lawn mower comprising: a drive source provided with a rotation shaft; a cutter blade extending in a direction intersecting the rotation shaft; and a housing provided with a peripheral wall configured to surround the cutter blade, wherein the cutter blade is provided with a cutting portion, the cutting portion being provided at least at a portion of the cutter blade that faces the peripheral wall, and the peripheral wall is provided with a protrusion protruding toward the rotation shaft.

According to the present invention, there is provided a lawn mower capable of more suitably mowing lawn grass.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view showing a lawn mower according to an embodiment of the present invention;

FIG. 2 is a bottom view of the lawn mower;

FIG. 3 is a cross-sectional view of the lawn mower;

FIG. 4 is a perspective view of a cutter blade; and

FIG. 5 is an enlarged view of a protrusion and the cutter blade.

### DETAILED DESCRIPTION OF THE INVENTION

### Embodiment

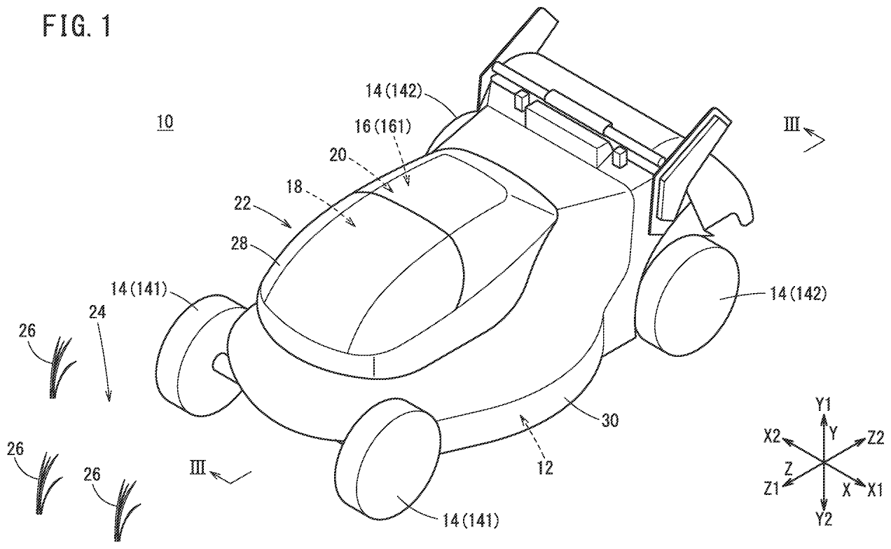

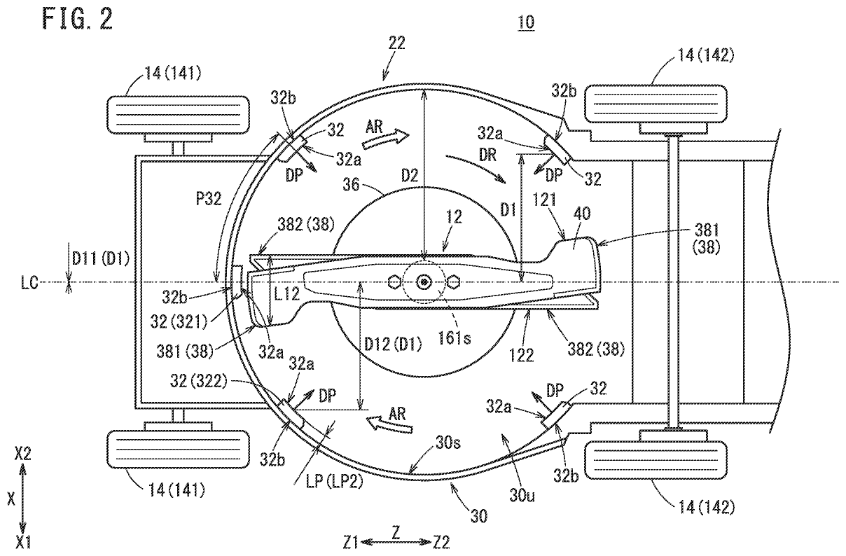

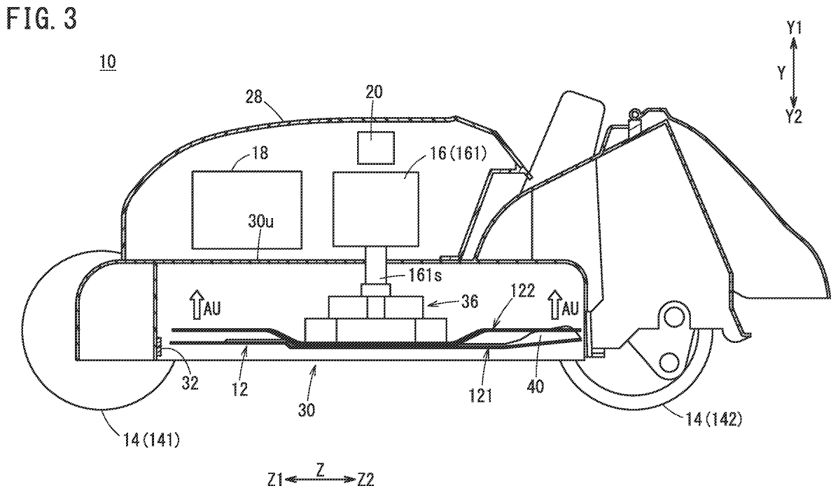

A lawn mower 10 according to an embodiment of the present invention will be described below with reference to the drawings. FIG. 1 is a perspective view showing the lawn mower 10 according to the embodiment. FIG. 2 is a bottom view of the lawn mower 10. FIG. 3 is a cross-sectional view of the lawn mower 10, taken along line III-III of FIG. 1.

The lawn mower 10 is a machine for cutting lawn grass 26 using a cutter blade 12. The lawn mower 10 includes the cutter blade 12, a plurality of wheels 14, a drive source 16, a battery 18, a control unit 20, and a housing 22. The cutter blade 12, the drive source 16, the battery 18, and the control unit 20 are accommodated in the housing 22.

The plurality of wheels 14 include two front wheels 141 and two rear wheels 142. The lawn mower 10 can travel on a traveling surface 24 by the rotation of the plurality of wheels 14. The number of the wheels 14 provided on the lawn mower 10 is not limited to four.

The drive source 16 includes a work motor 161. The work motor 161 is a motor for rotationally driving the cutter blade 12. The work motor 161 includes a rotation shaft 161s. The rotation shaft 161s extends downward. The rotation shaft 161s is rotationally driven by using the battery 18. The drive source 16 further includes a traction motor (not shown). The traction motor (not shown) is a motor for driving the wheels 14. The shaft of the traction motor (not shown) is driven by using the battery 18.

The control unit 20 is a computer that controls the lawn mower 10. The control unit 20 includes, for example, a processor and a memory. The memory stores a computer-executable program. The processor controls the lawn mower 10 by executing the program stored in the memory. For example, the processor controls the above-described drive source 16 based on the program. As a result, the control unit 20 can drive the cutter blade 12 and the wheels 14. At least a part of the control unit 20 may be configured by an integrated circuit, a discrete device, or the like.

The cutter blade 12 is provided at a lower portion of the lawn mower 10. The cutter blade 12 includes a plurality of blade members that rotate in response to driving of the work motor 161. More specifically, the cutter blade 12 includes a first blade member 121 and a second blade member 122. The first blade member 121 and the second blade member 122 are made of, for example, metal (alloy). Both the first blade member 121 and the second blade member 122 extend in a direction intersecting the rotation shaft 161s.

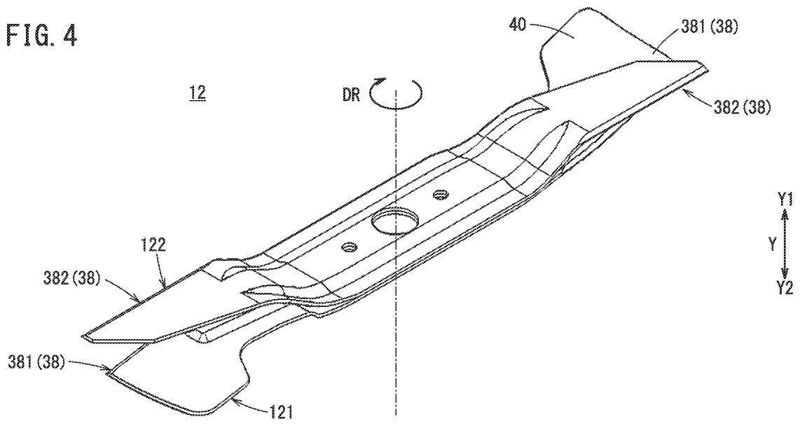

FIG. 4 is a perspective view of the cutter blade 12.

The first blade member 121 and the second blade member 122 are disposed so as to overlap each other in the thickness direction of the cutter blade 12. The second blade member 122 is located above the first blade member 121, but the present invention is not limited thereto.

The first blade member 121 and the second blade member 122 rotate integrally. More specifically, a blade holder 36 is connected to the rotation shaft 161s of the work motor 161 described above (see FIG. 3). The first blade member 121 and the second blade member 122 are attached to the blade holder 36 in a state of overlapping each other. As a result, the first blade member 121 and the second blade member 122 can rotate integrally in accordance with the rotation of the rotation shaft 161s while being supported by the blade holder 36.

The rotation position of the first blade member 121 in a rotation direction DR is different from the rotation position of the second blade member 122 in the rotation direction DR. More specifically, the rotation position of the first blade member 121 in the rotation direction DR is rearward of the rotation position of the second blade member 122 in the rotation direction DR.

The first blade member 121 includes first cutting portions 381 forming a cutting portion 38 for cutting the lawn grass 26. The cutter blade 12 is surrounded by a peripheral wall 30s (described later) provided in the housing 22. The first cutting portions 381 are each provided at least at a portion of the first blade member 121 that faces the peripheral wall 30s. More specifically, the first cutting portions 381 are provided at distal end portions of the first blade member 121 in the longitudinal direction thereof. The peripheral wall 30s will be described later in more detail.

The first blade member 121 further includes a wing portion 40. In accordance with the rotation of the first blade member 121, the wing portion 40 generates an upward airflow AU that is an airflow flowing in the upward direction (see also FIG. 3). The upward airflow AU causes the tip portion of the lawn grass 26 growing on the traveling surface 24 of the lawn mower 10 to stand vertically. Accordingly, the lawn grass 26 can easily come into contact with the cutting portion 38 described above. In other words, the lawn grass 26 can be easily cut by the cutting portion 38 of the cutter blade 12.

The second blade member 122 includes second cutting portions 382 forming the cutting portion 38 for cutting the lawn grass 26. The second cutting portions 382 are each provided at least at a portion of the second blade member 122 that faces the peripheral wall 30s. More specifically, the second cutting portions 382 are provided at least at distal end portions of the second blade member 122 in the longitudinal direction thereof.

The lawn mower 10 will be further described with reference to FIGS. 1 to 3 again. The housing 22 includes a motor accommodating portion 28 and a blade accommodating portion 30. In the present embodiment, a case where the motor accommodating portion 28 and the blade accommodating portion 30 are separate members will be described. However, the motor accommodating portion 28 and the blade accommodating portion 30 may be integrally formed.

The motor accommodating portion 28 accommodates the drive source 16. The blade accommodating portion 30 is located below the motor accommodating portion 28. The motor accommodating portion 28 can further accommodate the battery 18 and the control unit 20.

The blade accommodating portion 30 accommodates the cutter blade 12. As shown in FIG. 2, the shape of the blade accommodating portion 30 in plan view is, for example, a circular shape or a substantially circular shape, but the shape of the blade accommodating portion 30 is not limited thereto.

The blade accommodating portion 30 includes an upper wall 30u and the peripheral wall 30s. The upper wall 30u is a wall portion located above the cutter blade 12. In the present embodiment, the upper wall 30u also serves as the bottom portion of the motor accommodating portion 28, but the present invention is not limited thereto. The rotation shaft 161s of the work motor 161 described above passes through the upper wall 30u and is connected to the cutter blade 12. The peripheral wall 30s is a wall portion surrounding the cutter blade 12 in plan view. The peripheral wall 30s extends downward from the upper wall 30u.

Incidentally, the blade accommodating portion 30 has an open bottom. Therefore, the blade accommodating portion 30 does not hinder the cutter blade 12 from coming into contact with the lawn grass 26 growing on the traveling surface 24 of the lawn mower 10.

The peripheral wall 30s is provided with one or more protrusions 32 protruding toward the rotation shaft 161s. Hereinafter, a case where the peripheral wall 30s is provided with a plurality of the protrusions 32 will be described. The plurality of protrusions 32 are arranged along the rotation direction DR of the cutter blade 12 in plan view.

The protrusions 32 are members made of resin, for example. The protrusions 32 protrude in a protruding direction DP that is a direction from the protrusions 32 toward the rotation shaft 161s. These protrusions 32 can be attached to the inner surface of the peripheral wall 30s using screws or the like (not shown), but the present invention is not limited thereto.

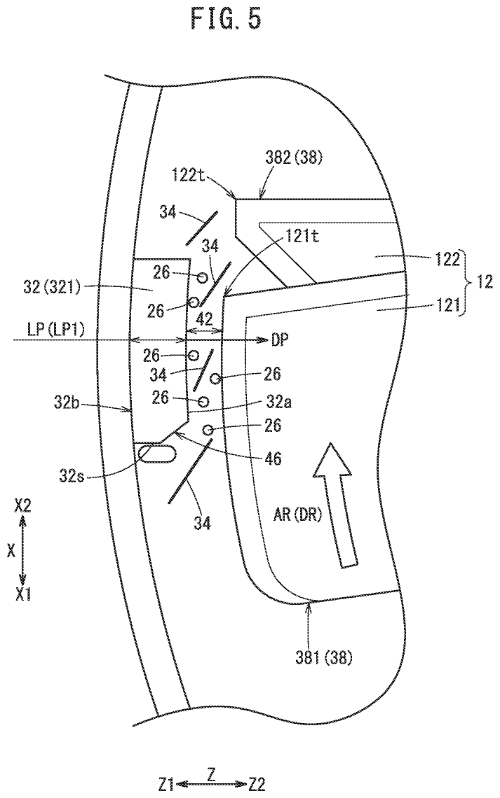

FIG. 5 is an enlarged view of the protrusion 32 and the cutter blade 12. A protrusion 321, which is one of the plurality of protrusions 32, is shown in FIG. 5.

When the cutter blade 12 is rotating, the protrusion 32 can face the cutting portion 38 (the first cutting portion 381 and the second cutting portion 382) provided on the cutter blade 12. Note that at least one of the first cutting portion 381 or the second cutting portion 382 may face the protrusion 32.

The cutting portion 38 and the protrusion 32 facing each other form a relatively narrow clearance 42. The size of the clearance 42 in the protruding direction DP is, for example, 2 mm to 5 mm, but the size of the clearance 42 is not limited thereto.

Since the clearance 42 between the cutting portion 38 and the protrusion 32 is relatively narrow, the lawn grass 26 can be caught between the cutting portion 38 and the protrusion 32. A force along the protruding direction DP can be applied to the lawn grass 26 caught between the cutting portion 38 and the protrusion 32. Since the cutting portion 38 moves while the force along the protruding direction DP is applied, the lawn grass 26 caught between the cutting portion 38 and the protrusion 32 can be favorably cut.

Incidentally, the peripheral wall 30s may be bent by an external force. When the peripheral wall 30s is bent, the cutter blade 12 may come into contact with the protrusion 32. If the rotating cutter blade 12 protrudes to the protrusion 32, the cutter blade 12 may be deformed, or damaged, for example. However, as described above, the protrusion 32 can be formed of resin. Resin is softer than metal. Therefore, even when the rotating cutter blade 12 comes into contact with the protrusion 32, it is possible to reduce the risk of deformation, damage, or the like of the cutter blade 12.

In order to cut the lawn grass 26 more favorably, the following structure is applied to the lawn mower 10.

As shown in FIG. 2, a pitch P32 between the protrusions 32 adjacent to each other in the rotation direction DR is set to be sufficiently large. The pitch P32 is larger than, for example, a length L12 of the cutter blade 12 in the rotation direction DR, but the size of the pitch P32 is not limited thereto.

The pitch P32 between the protrusions 32 adjacent to each other in the rotation direction DR is set to be relatively large, thereby reducing the risk of cut grass 34 being caught and remaining between the protrusions 32 adjacent to each other.

As shown in FIG. 2, it is preferable that the direction from the protrusions 32 toward the rotation shaft 161s does not coincide with (is not parallel to) a width direction X of the lawn mower 10. In other words, the protruding direction DP of the protrusions 32 preferably intersects the width direction X of the lawn mower 10. By configuring in this manner, a distance (a first distance) D1 from a center line LC of the lawn mower 10 to each of the protrusions 32 in the width direction X becomes shorter than a distance (a second distance) D2 between the rotation shaft 161s and the peripheral wall 30s. The first distance D1 is preferably 90% or less of the second distance D2, but the present invention is not limited thereto. The center line LC is an imaginary straight line that passes through the rotation shaft 161s and is parallel to a front-rear direction Z.

When each of the protrusions 32 is located at a position displaced from the rotation shaft 161s in the width direction X, the cut grass 34 that has fallen below the protrusion 32 is less likely to be cut again by the cutter blade 12. The generation of the cut grass 34 in such a state adversely affects the finish of mowing. On the other hand, according to the present embodiment, since the cut grass 34 that has fallen below the protrusion 32 can be cut again by the cutter blade 12, a good finish can be achieved.

As shown in FIG. 2, at least one of the plurality of protrusions 32 is disposed forward of the rotation shaft 161s. Further, at least one of the plurality of protrusions 32 is preferably located on the center line LC of the lawn mower 10.

As a result, the cut grass 34 falling below the protrusion 32 can be easily cut by the cutter blade 12. Specifically, by the rotation of the cutter blade 12, an airflow (rotational airflow) AR flowing in the rotation direction DR can be generated on the inner side of the peripheral wall 30s. Due to this rotational airflow AR, the cut grass 34 can flow in the rotation direction DR on the inner side of the peripheral wall 30s. When flowing in the rotation direction DR, the cut grass 34 may collide with the protrusion 32 and fall down. The cut grass 34 that has collided with the protrusion 32 located forward of the rotation shaft 161s can fall ahead of the rotation shaft 161s (the cutter blade 12). Since the lawn mower 10 moves forward, the cut grass 34 that has fallen ahead of the rotation shaft 161s is cut again by the cutter blade 12.

A protruding amount LP of each of the protrusions 32 preferably satisfies the following relationship. Specifically, when the distance D1 in the width direction X from the first protrusion 321 of the plurality of protrusions 32 to the center line LC is defined as a distance D11, and the distance D1 in the width direction X from a second protrusion 322 of the plurality of protrusions 32 to the center line LC is defined as a distance D12, the distance D11 is smaller than the distance D12. When the first protrusion 321 is located on the center line LC, the distance D11 is 0. The protruding amount LP (LP1) of the first protrusion 321 is larger than the protruding amount LP (LP2) of the second protrusion 322 (LP1>LP2). In this manner, it is preferable that the protruding amount LP of the protrusion 321 whose distance D11 from the center line LC is relatively small is set to be relatively large, and the protruding amount LP of the protrusion 322 whose distance D12 from the center line LC is relatively large is set to be relatively small.

Thus, the lawn grass 26 is more likely to be cut at the first protrusion 321 having the relatively large protruding amount LP, whereas the lawn grass 26 is less likely to be cut at the second protrusion 322 having the relatively small protruding amount LP. As a result, the amount of the cut grass 34 falling below the second protrusion 322 whose distance from the center line LC is relatively large can be reduced compared to the amount of the cut grass 34 falling below the first protrusion 321 whose distance from the center line LC is relatively small.

The protrusions 32 each include an inclined portion 46 (an inclined surface) inclined with respect to the protruding direction DP of the protrusion 32. The protrusions 32 each include a side portion 32s on the rear side in the rotation direction DR of the cutter blade 12. The inclined portion 46 inclined with respect to the protruding direction DP of the protrusion 32 is formed on the side portion 32s. The inclined portion 46 may be formed on the entire side portion 32s, or the inclined portion 46 may be formed on a part of the side portion 32s.

The cut grass 34 can flow along the inclined portion 46. The inclined portion 46 is inclined so that the cut grass 34 flows toward a protruding end of the protrusion 32.

Specifically, the protrusion 32 includes a distal end 32a and a proximal end 32b. Due to the inclined portion 46, the length of the distal end 32a of the protrusion 32 in the rotation direction DR of the cutter blade 12 is smaller than the length of the proximal end 32b of the protrusion 32 in the rotation direction DR.

Since the inclined portion 46 is formed on the protrusion 32, the cut grass 34 can be guided along the inclined portion 46. The cut grass 34 guided by the inclined portion 46 can be shredded by the cutting portion 38.

As described above, the rotation position of the first blade member 121 in the rotation direction DR is rearward of the rotation position of the second blade member 122 in the rotation direction DR. Therefore, after the cut grass 34 is guided to the protruding end of the protrusion 32 by the rotational airflow AR generated by the second blade member 122, the protruding end and the first cutting portion 381 of the first blade member 121 face each other. As a result, the cut grass 34 guided to the protruding end of the protrusion 32 can be easily shredded by the first cutting portion 381 of the first blade member 121.

As described above, according to the present embodiment, the lawn mower 10 capable of suitably mowing the lawn grass 26 is provided.

Note that the number of the blade members provided in the cutter blade 12 is not limited to two. That is, the number of the blade members provided in the cutter blade 12 may be one, or three or more.

Furthermore, as described above, the protrusions 32 are preferably made of resin, but the present invention is not limited thereto. For example, the protrusions 32 may be made of the same material as that of the peripheral wall 30s (the blade accommodating portion 30). In this case, the protrusions 32 and the peripheral wall 30s can be integrally formed. The peripheral wall 30s is made of, for example, metal (alloy), but the present invention is not limited thereto.

### APPENDICES

The following notes (appendices) are further disclosed in relation to the above-described embodiment.

### Appendix 1

The lawn mower (10) according to the present disclosure includes: the drive source (16) provided with the rotation shaft (161s); the cutter blade (12) extending in the direction intersecting the rotation shaft; and the housing (22) provided with the peripheral wall (30s) configured to surround the cutter blade, wherein the cutter blade is provided with the cutting portion (38), the cutting portion being provided at least at a portion of the cutter blade that faces the peripheral wall, and the peripheral wall is provided with the protrusion (32) protruding toward the rotation shaft. According to this feature, the lawn mower capable of suitably mowing the lawn grass is provided.

### Appendix 2

In the lawn mower according to Appendix 1, the protrusion may be provided in plurality, and the pitch (P32) between the protrusions adjacent to each other may be larger than the length (L12) of the cutter blade in the rotation direction (DR) of the cutter blade. According to this feature, it is possible to reduce the risk of the cut grass being caught and remaining between the adjacent protrusions.

### Appendix 3

In the lawn mower according to Appendix 1 or Appendix 2, the direction from the rotation shaft toward the protrusion may intersect the width direction (X) of the lawn mower. According to this feature, the cut grass that has fallen below the protrusion can be cut again by the cutter blade, so that a good finish can be achieved.

### Appendix 4

In the lawn mower according to Appendix 3, the distance (D1) in the width direction between the protrusion and the center line (LC) of the lawn mower that extends in the front-rear direction (Z) of the lawn mower may be 90% or less of the distance (D2) between the rotation shaft and the peripheral wall. According to this feature, the cut grass that has fallen below the protrusion can be cut again by the cutter blade, so that a good finish can be achieved.

### Appendix 5

In the lawn mower according to any one of Appendices 1 to 4, the protrusion may include the inclined portion (46) inclined with respect to the protruding direction (DP) of the protrusion. According to this feature, the cut grass can be easily guided toward the protruding end of the protrusion.

### Appendix 6

In the lawn mower according to any one of Appendices 1 to 5, the protrusion may be provided in plurality, the plurality of protrusions may include the first protrusion (321) and the second protrusion (322), the distance (D11) in the width direction of the lawn mower between the first protrusion and the center line of the lawn mower that extends in the front-rear direction of the lawn mower may be smaller than the distance (D12) in the width direction between the second protrusion and the center line, and the protruding amount (LP1) of the first protrusion may be larger than the protruding amount (LP2) of the second protrusion. According to this feature, the amount of the cut grass falling below the second protrusion can be reduced compared to the amount of the cut grass falling below the first protrusion.

### Appendix 7

In the lawn mower according to any one of Appendices 1 to 6, the cutter blade may include the first blade member (121) and the second blade member (122) disposed to overlap each other in the thickness direction of the cutter blade, and at least one of the first blade member or the second blade member may face the protrusion. According to this feature, the lawn grass can be cut favorably.

### Appendix 8

In the lawn mower according to Appendix 7, both the first blade member and the second blade member may face the protrusion. According to this feature, the lawn grass can be cut more favorably.

### Appendix 9

In the lawn mower according to Appendix 8, the protrusion may include the inclined portion inclined with respect to the protruding direction (DP) of the protrusion, the rotation position of the first blade member may be rearward of the rotation position of the second blade member, and the cutting portion may be provided at least at a portion of the first blade member that faces the peripheral wall. According to this feature, the cut grass can be easily shredded by the cutting portion of the first blade member.

### Appendix 10

In the lawn mower according to Appendix 9, the first blade member may be provided with the wing portion (40) configured to generate the airflow (AU) for making the lawn grass (26) stand up, in accordance with rotation of the first blade member. According to this feature, the lawn grass can be easily cut by the cutter blade.

### Appendix 11

In the lawn mower according to any one of Appendices 1 to 10, the protrusion may be located forward of the rotation shaft. According to this feature, when the lawn mower moves forward, the cut grass that has fallen ahead of the rotation shaft is cut by the cutter blade.

### Appendix 12

In the lawn mower according to Appendix 11, the protrusion may be located on the center line of the lawn mower that extends in the front-rear direction of the lawn mower. According to this feature, when the lawn mower moves forward, the cut grass that has fallen ahead of the rotation shaft is cut by the cutter blade.

### Appendix 13

In the lawn mower according to any one of Appendices 1 to 12, the protrusion may be made of resin. According to this feature, it is possible to reduce the risk of deformation, damage, or the like of the cutter blade due to interference with the protrusion.

### Appendix 14

In the lawn mower according to any one of Appendices 1 to 13, the distance between the protrusion and the cutter blade when the protrusion and the cutter blade face each other may be in a range of 2 mm to 5 mm.

The present invention is not limited to the above disclosure, and various modifications are possible without departing from the essence and gist of the present invention.

1. A lawn mower comprising:
a drive source provided with a rotation shaft;
a cutter blade extending in a direction intersecting the rotation shaft; and
a housing provided with a peripheral wall configured to surround the cutter blade,
wherein the cutter blade is provided with a cutting portion, the cutting portion being provided at least at a portion of the cutter blade that faces the peripheral wall, and
the peripheral wall is provided with a protrusion protruding toward the rotation shaft from a surface of the peripheral wall that faces a direction of the rotation shaft.

2. The lawn mower according to claim 1, wherein
the protrusion comprises a plurality of protrusions disposed to be separated from each other in a rotation direction of the cutter blade, and
a pitch between the protrusions adjacent to each other is larger than a length of the cutter blade in the rotation direction.

3. The lawn mower according to claim 1, wherein
the protrusion is disposed in a manner so that a direction from the rotation shaft toward the protrusion intersects a width direction that is a direction orthogonal to a front-rear direction in a traveling direction of the lawn mower.

4. The lawn mower according to claim 3, wherein
a distance in the width direction between a distal end of the protrusion and a center line that extends in the front-rear direction in the traveling direction of the lawn mower and passes through the rotation shaft is 90% or less of a distance between the rotation shaft and the peripheral wall.

5. The lawn mower according to claim 1, wherein
the protrusion includes an inclined portion inclined with respect to a protruding direction of the protrusion.

6. The lawn mower according to claim 1, wherein
the protrusion comprises a plurality of protrusions disposed to be separated from each other in a rotation direction of the cutter blade,
the plurality of protrusions include a first protrusion and a second protrusion,
a distance in a width direction between a distal end of the first protrusion and a center line that extends in a front-rear direction in a traveling direction of the lawn mower and passes through the rotation shaft is smaller than a distance in the width direction between a distal end of the second protrusion and the center line, the width direction being a direction orthogonal to the front-rear direction, and
a protruding amount of the first protrusion is larger than a protruding amount of the second protrusion.

7. The lawn mower according to claim 1, wherein
the cutter blade includes a first blade member and a second blade member disposed to overlap each other in an extending direction of the rotation shaft, and
at least one of the first blade member or the second blade member and the protrusion are disposed at positions overlapping each other in the extending direction.

8. The lawn mower according to claim 7, wherein
both the first blade member and the second blade member, and the protrusion are disposed at positions overlapping each other in the extending direction.

9. The lawn mower according to claim 8, wherein
the first blade member and the second blade member are provided so as to be non-rotatable relative to each other,
the protrusion includes an inclined portion inclined with respect to a protruding direction of the protrusion,
in a rotation direction of the cutter blade, distal end of the first blade member in the rotation direction is rearward of a distal end of the second blade member in the rotation direction, and
the cutting portion is provided at least at a portion of the first blade member that faces the peripheral wall.

10. The lawn mower according to claim 9, wherein
the first blade member is provided with a wing portion, and
the wing portion includes a surface extending from the first blade member in an upward direction that intersects a longitudinal direction of the first blade member.

11. The lawn mower according to claim 1, wherein
the protrusion is located forward of the rotation shaft in a front-rear direction in a traveling direction of the lawn mower.

12. The lawn mower according to claim 11, wherein
the protrusion is located on a center line that extends in the front-rear direction in the traveling direction of the lawn mower and passes through the rotation shaft.

13. The lawn mower according to claim 1, wherein
the protrusion is made of resin.

14. The lawn mower according to claim 1, wherein
the protrusion includes a distal end in a protruding direction of the protrusion,
the cutter blade includes a distal end in a longitudinal direction of the cutter blade, and
a distance in the protruding direction between the distal end of the protrusion and the distal end of the cutter blade when a position of the distal end of the protrusion and a position of the distal end of the cutter blade match each other in a rotation direction of the cutter blade is in a range of 2 mm to 5 mm.
